(19) United States
(12) Patent Application Publication
(10) Pub. No.: US 2011/0033733 A1
(43) Pub. Date: Feb. 10, 2011

(54) Duel Configuration Rechargeable Battery and Vehicle

(76) Inventor: Norman Ken Ouchi, San Jose, CA (US)

Correspondence Address: NORMAN KEN OUCHI, P.O. BOX 20111, SAN JOSE, CA, 95160, US

(21) Appl. No.: 12/535,861

(22) Filed: Aug. 5, 2009

(51) Int. Cl. H01M 10/42; H01M 4/02

(52) U.S. Cl. 429/49; 429/209

(57) ABSTRACT

The present invention is a dual configuration rechargeable battery for an electric powered vehicle where the battery in a first configuration provides a first chemical reaction discharging a battery electrolyte to generate an electrical current and with a reverse current, recharging the battery; and in a second configuration provides a second chemical reaction to generate a reverse electrical current and recharging the battery so that the battery returned to the first configuration is charged. The chemical for the second reaction is depleted and must be replenished to repeat the cycle. The battery in the second configuration provides both the recharging of the electrolyte and an electrical current for an electric powered vehicle while recharging. The charging current are equivalent to the discharging current so that the battery can be designed for operational current and not higher charging currents. Unlike recharging from an external source such as the power grid, the battery is used while recharging.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

This invention is related to rechargeable batteries for electric powered vehicles.

### BRIEF SUMMARY OF THE INVENTION

The present invention is a dual configuration rechargeable battery for an electric powered vehicle where the battery in a first configuration provides a first chemical reaction discharging a battery electrolyte to generate an electrical current and with a reverse current, recharging the battery; and in a second configuration provides a second chemical reaction to generate a reverse electrical current and recharging the battery so that the battery returned to the first configuration is charged. The chemical for the second reaction is depleted and must be replenished to repeat the cycle. The battery in the second configuration provides both the recharging of the electrolyte and an electrical current for an electric powered vehicle while recharging. The charging current is equivalent to the discharging current so that the battery can be designed for operational current and not higher charging currents. Unlike recharging from an external source such as the power grid, the battery is used while recharging. An infrastructure to support the recharging materials and recycling of the battery recharging materials are disclosed. The examples illustrated in the equations are for a lithium air secondary battery where the anode is oxygen provided by the environment.

### BACKGROUND OF THE INVENTION

Lithium oxygen or air batteries use the oxygen from the environment to oxidize lithium while generating an electric current. The battery is significantly lighter than other batteries because the oxygen for the anode is extracted from the environment (air or water with dissolved oxygen) and not carried in the battery. Lithium is the lightest metal further reducing the battery weight. Lithium oxygen batteries promise very high energy densities and electric vehicles with 500 mile range. However, drivers would like extended range and faster recharge of the battery. Longer drive times equate to longer recharge times. A battery with a charge for 500 miles of travel must recharge that amount of energy and more due to losses. A 500 mile trip would take at least 10 hours and the recharge at the same rate as the discharge may be much more than 10 hours. Faster recharge rates require higher current capabilities and power absorption by the battery and provided by the electrical source. The laws of physics require the amount of energy extracted from a rechargeable battery must be replenished and the recharge rates will have as an upper bound the sustainable extraction rate. What comes out must match what goes in minus losses. For fast recharge rates, the bulk of the battery may have to be designed for recharging rather than for its primary use in the vehicle. Lithium oxygen batteries provide high energy capacity at low current loads and fast recharge capabilities may be difficult to achieve.

The acceptance of pure electric vehicles may be limited even if most drivers do not make long distance trips. Drivers want the ability to travel without consideration of long recharge stops. “Plug-in” hybrid cars have the advantage of extended range after the initial battery charge is exhausted. Even if most drivers would never exhaust the battery range on most trips and recharge the battery overnight, knowing that the range can be extended with the addition of fuel is a major selling point. Of course, the plug in hybrid must carry the mass of the gasoline engine, complex power transfer system, and associated added cost. With gasoline engine vehicles, drivers only stop for a short time to refill the tank and the vehicle can continue; the use is only limited by the endurance of the drivers, who may exchange with passengers to be drivers, which can be essentially unlimited. The network of gasoline service stations is well established and drivers have assurance that most trips can be completed without significant pre-planning for fuel stops.

Proposals for battery exchanges, etc. would require significant infrastructure investments and agreements. Witness the multiple configurations of lap top batteries. Imagine how many configurations would be needed for road vehicles. Also, battery usage requires tracking since batteries wear and equitable exchanges established. Changing batteries is a far cry from buying gasoline from a pump. Also, when should a battery be exchanged?

When exhausted? Of course this is desirable. With gasoline, a partially empty tank can be filled. However, would a driver exchange a partially charged battery when the next battery exchange location is further than the remainder of the battery charge? Would the driver receive credit for the remaining charge?

Proposals to exchange the lithium cathodes rather than the complete battery have even more complex issues.

Proposals for electrical “refuel” stations including public parking lots and office building lots are considered and pilot networks have been established. However, the vehicle must be recharged for an extended time to recover the energy expended. This is not a short fuel stop as with a gasoline powered vehicle.

What is desired is an electric powered vehicle that provides the extended range capabilities similar to a plug in hybrid car without the added cost and mass of a gasoline powered recharging functions.

### BRIEF DESCRIPTION OF DRAWINGS

FIG. 1 illustrates
Equation 1, for the battery in the first configuration, the chemical reaction for the electrolyte going from the reduced state to the compound state generating an electric current;
Equation 2, the chemical reaction for the battery in the first configuration, the electrolyte going from the compound state to the reduced state driven by an applied reverse current;
Equation 3, the chemical reaction, for the battery in the second configuration, the electrolyte going from the compound state to the reduced state generating a reverse electric current;
Equation 4, the chemical reaction, for the battery in the second configuration, the electrolyte going from the reduced state to the compound state driven by an applied current;

FIG. 2A illustrates the battery in the first configuration connected to a motor and the generated current flow and the Equation 1 chemical reaction.

FIG. 2B illustrates the battery in the first configuration connected to a motor and the applied reverse current flow and the Equation 2 chemical reaction.

FIG. 2C illustrates the battery in the first configuration connected to an external charger and the applied reverse current flow and the Equation 2 chemical reaction.

FIG. 3A illustrates the battery in the second configuration connected to a motor and the generated reverse current flow and the Equation 3 chemical reaction.

FIG. 3B illustrates the battery in the second configuration connected to a motor and the applied current flow and the Equation 4 chemical reaction.

FIG. 3C illustrates the battery in the second configuration connected to an external charger and the applied current flow and the Equation 4 chemical reaction.

FIG. 4A illustrates a vehicle powered by an electric motor connected to the dual configuration battery with a cross over switch and storage tank.

FIG. 4B illustrates a vehicle powered by an electric motor connected to the dual configuration battery with a cross over switch and storage tank and the reducing chemical recycling unit with the chemical reaction for recycling depleted reducing chemical with an applied current.

FIG. 5A illustrates the storage tank with two compartments for non-depleted reducing chemical and depleted reducing chemical.

FIG. 5B illustrates Equation 6, the chemical reaction for the battery in the second configuration, electrolyte lithium oxide and reducing chemical sodium reacting to form lithium in the reduced state and sodium oxide and generating a reverse electrical current.

FIG. 6A illustrates the layers and chemical reactants in a lithium oxygen rechargeable battery in the first configuration with the Equation 1 reaction that produces an electric current.

FIG. 6B illustrates the layers and chemical reactants in a lithium oxygen rechargeable battery in the second configuration with lithium oxide and sodium to produce the Equation 6 reaction and reverse electrical current.

FIG. 7 illustrates
Equation 7, for the battery in the second configuration, the chemical reaction of lithium oxide with water to form lithium hydroxide with a generated current;
Equation 8, for the battery in the second configuration, the reaction of lithium hydroxide with sodium to form reduced lithium and sodium hydroxide with a generated reverse current;
Equation 9, the reaction to reverse sodium hydroxide back to sodium, water, and oxygen by application of an electrical current.

FIG. 8A illustrates the layers and chemical reactants in a lithium oxygen rechargeable battery in the second configuration with the Equation 7 reaction that produces an electric current.

FIG. 8B illustrates the layers and chemical reactants in a lithium oxygen rechargeable battery in the second configuration with the Equation 8 reaction that produces a reverse electric current.

### DESCRIPTION OF THE INVENTION

The present invention is a dual configuration rechargeable battery for use in an electric powered vehicle where the battery provides a configuration to recharge the battery while generating an electric current to power the vehicle. In a first configuration, the battery provides a first chemical reaction discharging a battery electrolyte material to generate an electrical current and with a reverse current, recharging the battery material with a reverse chemical reaction; and in the second configuration provides a second chemical reaction to generate a reverse electrical current and charge the battery material so that the battery returned to the first configuration is charged. The battery in the second configuration provides both a recharging of the electrolyte and an electrical current, albeit in the reverse polarity, during the charging period. The chemical providing the second chemical reaction is depleted by the reaction and must be replenished to repeat the cycle. The charging current is equivalent to the discharging current so the battery can be designed for the operational current and not higher charging currents. Unlike recharging from an external source such as the power grid, the battery is in use during the recharging process. A function to supply and recycle the recharging chemicals is disclosed. The examples illustrated in the equations are for a lithium air secondary battery where the anode is oxygen provided by the environment.

### First Configuration

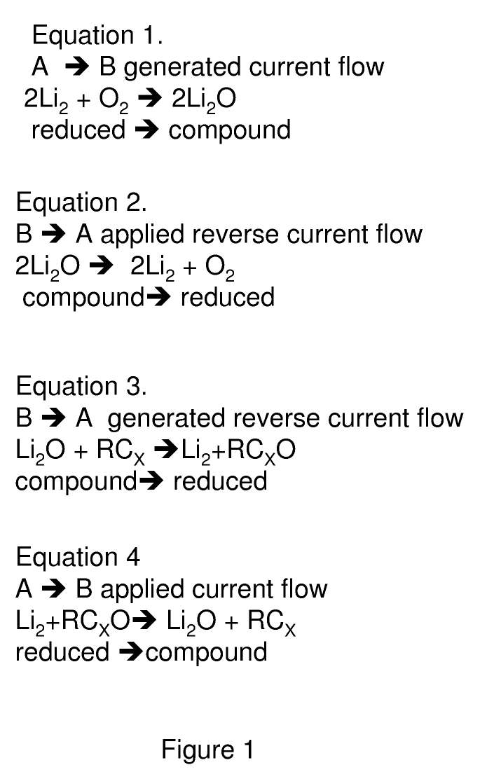

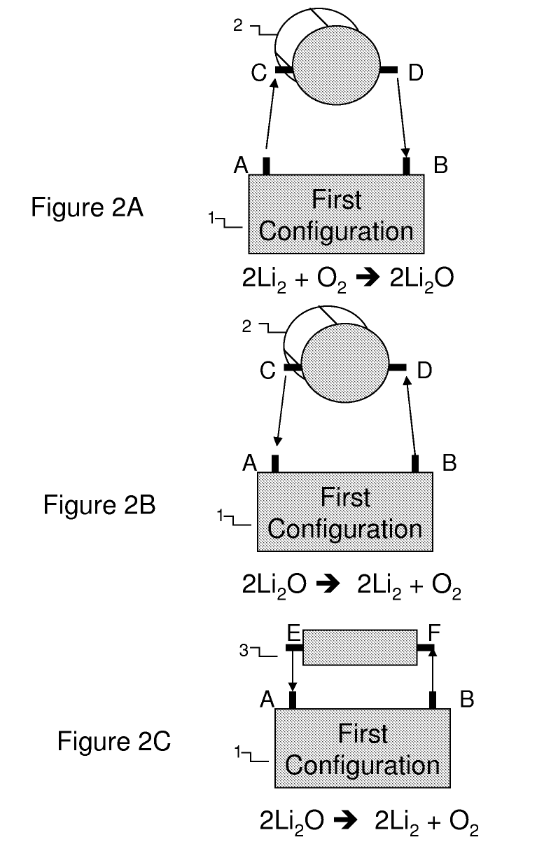

The dual configuration rechargeable battery provides a first configuration where the battery discharges to power the electric motor and is charged by regenerative operation of the electric motor, for example, breaking, or by an external electrical power. In this configuration, the battery operates as a rechargeable battery where a two state electrolyte changes from a reduced state to a compound state by a chemical reaction to generate an electrical current and from the compound state to the reduced state by applying a reverse electrical current, e.g. regenerative breaking, that causes a reverse chemical reaction. Equation 1 illustrates the chemical reaction and generated current flow for an electrolyte, Li (lithium), converted from the reduced state, 2Li₂, to the compound state, 2Li₂O, (lithium oxide) in reaction with O₂ (oxygen) from the environment. Equation 2 illustrates the applied reverse current flow and generated chemical reaction for the electrolyte changing from the compound state, 2Li₂O to the reduced state 2Li₂ with the liberation of O₂, oxygen. Note the quantities of each element are to balance the equations with diatomic oxygen O₂. The first configuration with an electric motor is illustrated in FIG. 2A where an electric motor 2 is connected to a dual configuration battery 1 where battery terminal A is connected to motor terminal C and battery terminal B is connected to motor terminal D. When motor 2 is powered by the battery 1, current flows from battery terminal A to motor terminal C, powering the motor 2 to motor terminal D to battery terminal B, where the illustrated chemical reaction powers the battery 1. Illustrated in FIG. 2B when the battery 1 is recharged by the motor 2, for example during regenerative breaking, current flows from motor terminal C to battery terminal A, recharging the battery 1 to battery terminal B to motor terminal D, where the illustrated chemical reaction is driven in battery 1 by the applied reverse current. Illustrated in FIG. 2C, the battery 1 is recharged by a charger 3, for example from an electrical grid, where current flows from charger terminal E to battery terminal A, recharging the battery 1 to battery terminal B to charger terminal F, where the illustrated chemical reaction is driven in battery 1 by the applied reverse current.

### Second Configuration

In the second configuration, the battery 1 operates as a rechargeable battery where the two state electrolyte changes from a compound state to a reduced state by a chemical reaction with a reducing chemical to generate a reverse electrical current and from the reduced state to the compound state driven by an applied electrical current that causes a reverse chemical reaction. Equation 3 illustrates the chemical reaction and generated reverse current flow for the electrolyte, Li (lithium), converted from the compound state, Li₂O, to the reduced state, Li₂, in reaction with RC_{X} (reducing chemical) to form RC_{X}O, depleting the reducing chemical. Equation 4 illustrates the applied current flow driving the chemical reaction for the electrolyte changing from the reduced state, Li₂ to the compound state Li₂O and forming non-depleted RC_{X}. In the chemical reaction between the compound state electrolyte and reducing chemical, the reducing chemical is depleted while changing the electrolyte to the reduced state and generating a reverse current; and, transformed to a non-depleted state when the electrolyte is changed to the compound state with the reaction driven by an applied current.

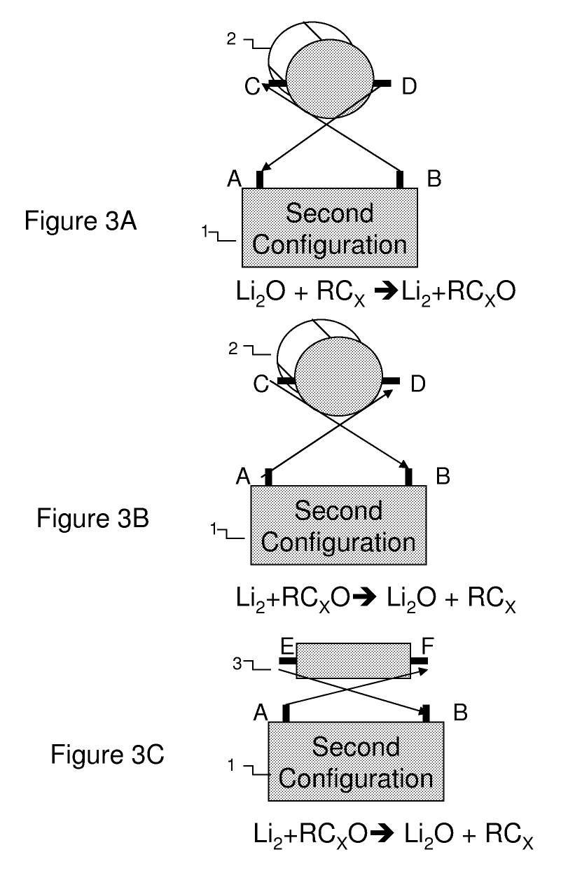

The second configuration provides the vehicle with an extended range capability where the battery 1 operates in the first configuration while electrical recharging facilities and time to recharge are available and the battery 1 is converted to the second configuration to charge the battery 1 with the reducing chemical while providing current for the motor 2. The second configuration with the electric motor 2 is illustrated in FIG. 3A where an electric motor 2 is connected to a dual configuration battery 1 where battery terminal A is connected to motor terminal D and battery terminal B is connected to motor terminal C. Note that the terminals are switched because the chemical reaction flows in the reverse direction where battery terminal B now acts as a cathode to battery terminal A which now acts as an anode. When motor 2 is powered by the battery 1, current flows from battery terminal B to motor terminal C, powering the motor 2 to motor terminal D to battery terminal A, where the illustrated chemical reaction powers the battery 1. Illustrated in FIG. 3B when the battery 1 is recharged by the motor 2, during regenerative breaking for example, current flows from motor terminal C to battery terminal B, recharging the battery 1 to battery terminal A to motor terminal D, where the illustrated chemical reaction is driven in battery 1 by the applied current. Illustrated in FIG. 3C when the battery 1 is recharged by a charger 3, for example from an electrical grid, current flows from charger terminal E to battery terminal B, recharging the battery 1 to battery terminal A to charger terminal F, where the illustrated chemical reaction is driven in battery 1 by the applied current. When extended range is required, the battery 1 is converted to the second configuration with a supply of non-depleted reducing chemical. After the delay to reconfigure the battery 1 and apply the reducing chemical, the battery 1 operates with the reversing the reaction on the electrolyte taking it from the compound state to the reduced state while depleting the reducing chemical. When the reducing chemical is completely depleted, the battery 1 is reconfigured to the first configuration, the depleted reducing chemical is removed, and the battery 1 operates by chemical reaction that changes the electrolyte from the reduced state to the compound state. It is envisioned that the conversion time between the two configurations is not long, measured in minutes, equivalent to the time to fuel a gasoline vehicle.

### Vehicle

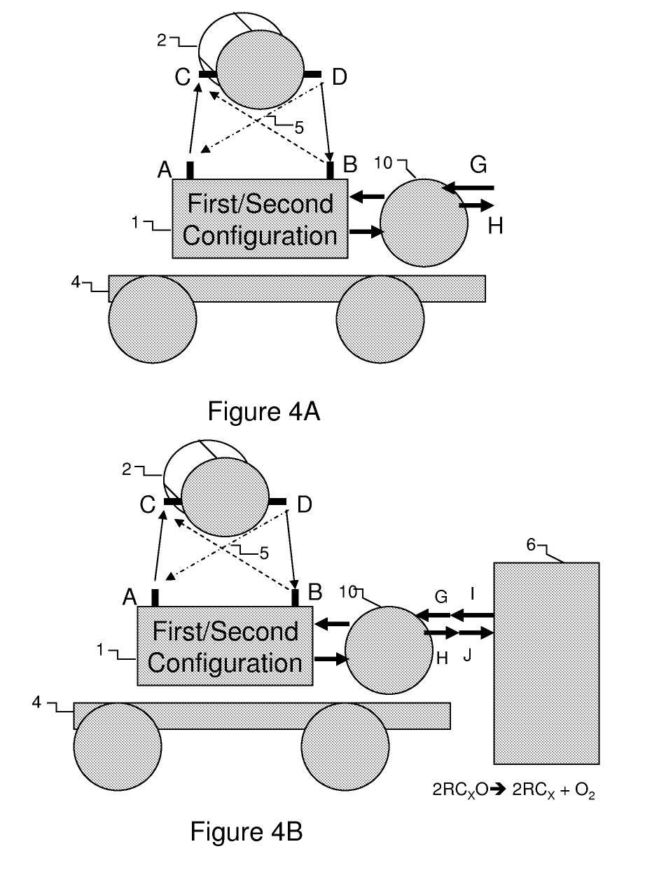

Illustrated in FIG. 4A, a vehicle 4 with the dual configuration rechargeable battery 1 operates as an electric powered vehicle with electrical power from the battery 1 with the extended range capability similar to a hybrid electric vehicle without the mass and expense of the recharging gasoline engine, power conversion system, and gasoline tank. In the extended range mode, the vehicle would switch between the two configurations with a cross switch 5 to configure the battery 1 terminal A and terminal B and motor 2 terminal C and terminal D in the appropriate connections and replenishing the depleted reducing chemical at reducing chemical stations. It is envisioned that reducing chemical stations be located much as gasoline stations are located and that the reducing chemical be recycled at these stations with the application of a reverse current.

### Vehicle Storage Tank

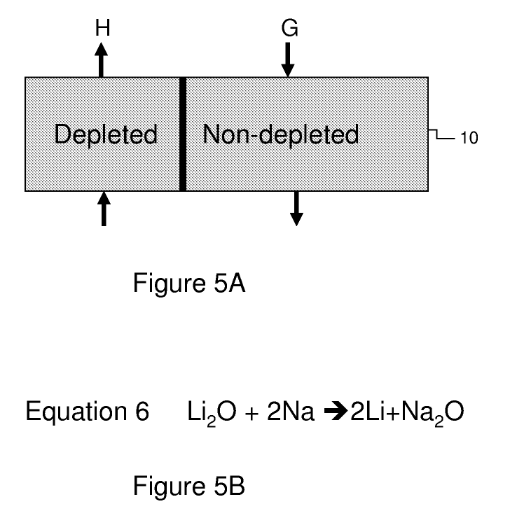

To facilitate the ease of use of the reducing chemical, the vehicle 4 may have a storage tank 10 to hold reducing chemical until used. The storage tank 10 provides an input G the tank may be filled and an output H so that the tank can be filled or emptied without exposing the reducing chemical to the environment. The storage tank 10 illustrated in FIG. 5A comprises two compartments where one is used for non-depleted reducing chemical and the other is used for depleted reducing chemical. The two compartments may share a movable or flexible barrier or separate bladders such that the total capacity is fixed but the amounts of non-depleted reducing chemical and depleted reducing chemical may vary as long as the total amount does not exceed the fixed total tank capacity. The storage tank 10 capacity may be equal to, greater than, or less than the capacity of the battery 1. The battery 1 may be partially filled in the second configuration and depending on the storage tank 10 capacity, the battery 1 may be cycled between the two configurations to use the reducing chemical at the convenience of the driver and the locations of the reducing chemical facilities along the route traveled.

### Reducing Chemical Recycling

Depleted reducing chemical may be converted the non-depleted state by the application of an appropriate electric current. It is envisioned that the depleted reducing chemical in storage tank 10 of a vehicle is transferred through connector J that mates with the vehicle connector H to a recycling processor 6 illustrated in FIG. 4B where the depleted reducing chemical is filtered, cleaned, and then converted to the non-depleted state by the application of a reverse current as illustrated in Equation 4 of FIG. 1. The non-depleted reducing chemical is stored in a holding tank for later transfer for use to a vehicle where connector I that mates with the vehicle connector G to transfer non-depleted reducing chemical to the storage tank 10.

Unlike gasoline where the stations are replenished by tanker trucks, the reducing chemical stations would recycle reducing chemicals for a significant fraction of their supply. Tanker trucks would deliver modest amounts to replenish losses or to balance net transportation of traffic where more vehicles travel in one direction rather than the opposite direction.

### EMBODIMENTS OF THE INVENTION

The lithium air battery 1 produces lithium oxide, Li₂O, as the electrolyte compound state. Lithium oxide compounds are basic anhydrides and can therefore react with acids and with strong reducing agents in redox reactions. The lithium oxide in the battery 1 in the second configuration reacts with a reducing chemical to reduce lithium oxide to lithium and generate a reverse electrical current. Two implementations are described where in a first implementation, sodium is the reducing chemical and in the second implementation, water converts lithium oxide to lithium hydroxide and then sodium coverts lithium hydroxide to lithium and sodium hydroxide.

The battery 1 to motor 2 connections pass through cross switch 5 to route the current or reverse current generated in the battery 1 thought the motor 2.

In changing from the first configuration to the second configuration, the air anode is replaced by the reducing chemical cathode by closing off the air supply inlets to provide a closed cathode for the reducing chemical. The configuration one cathode now serves as an anode. In reversing the cathode for the second configuration to the anode of the first configuration, the reducing chemical is flushed from the enclosed cathode and the air supply inlets are opened for the air anode. Membranes that separate the electrolytes may be changed for each configuration to permit specific ion passage.

### Reducing Chemical, Sodium

### First Configuration

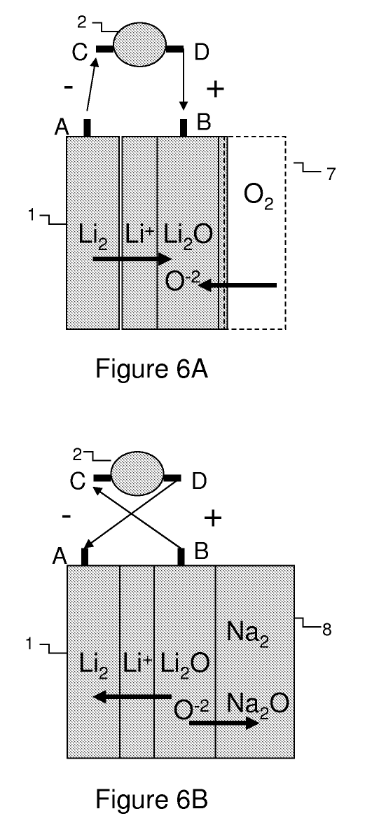

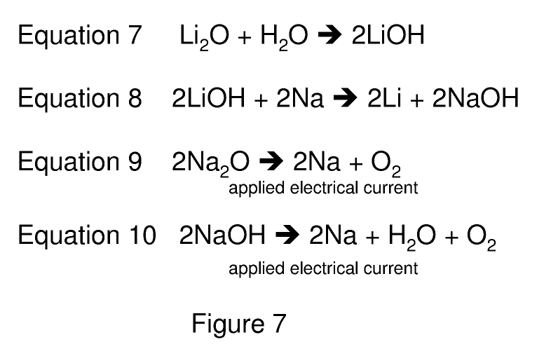

The lithium air battery 1 in the first configuration is illustrated as FIG. 6A where lithium, Li₂, is the negative cathode in reduced state; lithium ions, Li+, flow to combine with oxygen, O₂, from the air as an oxygen ion, O⁻², provided by the air anode 7 to form lithium oxide, Li₂O, and generating a current from terminal A to terminal C through electric motor 2 to terminal D to terminal B. The chemical reaction is illustrated as Equation 1. With back electromotive force breaking on the electric motor 2 or an external charger drawing current from external sources such as the power grid, the current is reversed and chemical reaction reverses as illustrated in Equation 2. The first configuration provides an air anode 7 with a barrier permeable to O⁻² ions while preventing the entry of water.

### Second Configuration

The lithium air battery 1 is configured to second configuration as illustrated in FIG. 6B where the air anode 7 is replaced with a sodium, Na, cathode 8 (where the sodium is in colloidal form in a carbon or other inherit matrix that permits interaction with the lithium oxide as the anode and conduction as a cathode) and the connection from terminal B is now to motor terminal C and from terminal A to motor terminal D. The reducing chemical sodium removes the oxygen ion, O⁻², from lithium oxide Li₂O converting the lithium to the lithium ion L⁺ generating a reverse current from terminal B to terminal C through electric motor 2 to terminal D to terminal A. The sodium is depleted by conversion to sodium oxide, Na₂O. The chemical reaction is illustrated in Equation 6. With back electromotive force breaking on the electric motor 2, the current drives the chemical reaction illustrated in Equation 6 in reversed resulting in lithium oxide and sodium. When the reducing chemical sodium is depleted, the Na cathode 8 is removed and the air anode 7 restored configuring the battery 1 to the first configuration.

One of ordinary skill can devise other reducing chemicals including potassium and organic reducing chemicals.

### Reducing Chemicals—Water and Sodium—a Two Step Second Configuration

### First Configuration

The lithium air battery 1 in the first configuration is illustrated in FIG. 6A where lithium, Li₂, is the negative cathode in reduced state; lithium ions, Li⁺, flow to combine with oxygen, O₂, from the air as an oxygen ion, O⁻², provided by the air anode 7 to form lithium oxide, Li₂O, and generating a current from terminal A to terminal C through electric motor 2 to terminal D to terminal B. The chemical reaction is illustrated as Equation 1. With back electromotive force breaking on the electric motor 2, the current is reversed and chemical reaction reverses as illustrated in Equation 2. The first configuration provides an air anode 7 with a barrier permeable to O₂ while preventing the entry of water.

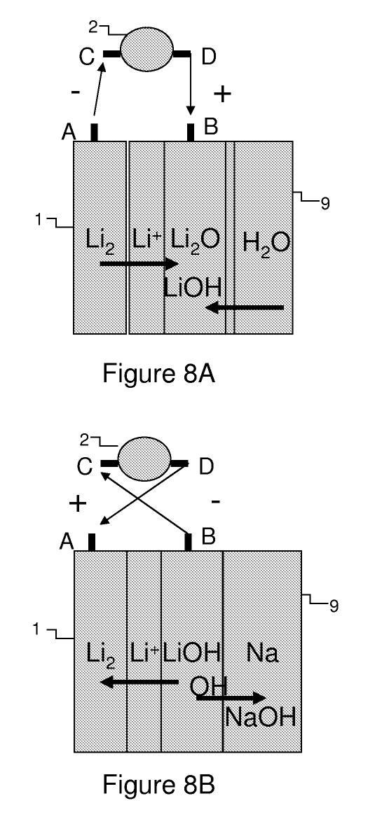

Second Configuration A Step The lithium air battery 1 is configured to the A step of the second configuration as illustrated in FIG. 8A where the air anode 7 is replaced with liquid anode 9 and the connection from terminal A is to motor terminal C and from terminal B to motor terminal D. Water, H₂O, transfers and combines with lithium oxide Li₂O converting to lithium hydroxide, LiOH, generating a current from terminal A to terminal C through electric motor 2 to terminal D to terminal B. The chemical reaction is illustrated in Equation 7. With back electromotive force breaking on the electric motor 2, the current is reversed and chemical reaction is driven in reverse.
Second Configuration B Step When the water or Li₂O is depleted, any remaining water is removed and sodium, Na, is introduced into anode 9 to configure battery 1 into B step of the second configuration as illustrated in FIG. 8B and the connection from terminal B connects to motor terminal C and motor terminal D connects to terminal A. The sodium reacts with the lithium hydroxide to form sodium hydroxide and reduced lithium and generates a reverse current from terminal B to terminal C through motor 2 to terminal D to terminal A. The chemical reaction is illustrated in Equation 8. With back electromotive force breaking on the electric motor 2, the reverse current is reversed and drives the chemical reaction in reverse. When the sodium anode depleted by conversion to sodium hydroxide, anode 9 is removed and replaced with air anode 6; terminal A is connected to terminal C and terminal B is connected to terminal D; restoring battery 1 to the first configuration with a charged lithium cathode.

### Recovery of Depleted Reducing Chemicals

The depleted reducing chemical are recovered and returned to the non-depleted state by the application of an electrical current with a suitable cathode. The recovery reaction for sodium oxide is illustrated in Equation 9 where sodium and oxygen gas are the formed. The sodium hydroxide recovery reaction is illustrated in Equation 10 where sodium, water, and oxygen gas are formed. Additional chemical are not required and the recovery of the reducing chemicals can be performed at the “filling station” with a connection to a power grid as an electrical source. Since the recovery reaction need not be designed for a vehicle, the electrical conductors and supporting structure can be designed for rapid recovery of large quantities of depleted reducing chemicals. With rapid recovery, the total amount of reducing chemicals for a transportation system can be minimized. The recovery/recycling facility provides means to extract the depleted reducing chemical from the vehicle battery or storage tank, means to store the depleted reducing chemical, means to process the depleted reducing chemical by application of a current to transform the depleted reducing chemical to non-depleted reducing chemical; means to store the non-depleted reducing chemical; and means to transfer non-depleted reducing chemical to the vehicle battery or storage tank.

It is expected that the recovery/recycling facilities will provide much of non-depleted reducing chemical by recycling rather than from external sources.

I claim:

1. A dual configuration rechargeable battery comprising:
a two state electrolyte with a reduced state and an compound state where chemical reactions change the states with a resultant electrical flow or an electrical flow changes the state with resultant chemical reactions;
a dual use electrode associated with the two state electrolyte, which serves as a cathode in a first configuration and an anode in a second configuration;
an atmospheric electrode acting as an anode in the first configuration where atmospheric gases can enter into chemical reactions with the two state electrolyte in the reduced state resulting in the compound state and electrical flow with the dual use electrode as a cathode;
a reducing chemical electrode acting as a cathode in the second configuration where the reducing chemical enters into a chemical reaction with the two state electrolyte in the compound state resulting in the reduced state, depletion of the reducing chemical electrode, and electrical flow with the dual use electrode as an anode;
where the battery in the first configuration generates an electrical flow with the atmospheric electrode by a chemical reaction changing the two state electrolyte from the reduced state to the compound state and in the second configuration generates an electrical flow with the reducing chemical by a chemical reaction changing the two state electrolyte from the compound state to the reduced state.

2. The dual configuration rechargeable battery of claim 1 wherein with the battery in the first configuration, the two state electrolyte is converted from the compound state to the reduced state by application of a reverse electrical current to the dual use electrode as a cathode and atmospheric electrode as an anode.

3. The dual configuration rechargeable battery of claim 1 wherein the battery is changed from the first configuration to the second configuration by replacing the atmospheric anode with the reducing chemical cathode and changing the dual use electrode from cathode to anode.

4. The dual configuration rechargeable battery of claim 1 wherein the battery is changed from the second configuration to the first configuration by replacing the reducing chemical cathode with the atmospheric anode and changing the dual use electrode from anode to cathode.

5. The dual configuration rechargeable battery of claim 1, wherein the atmospheric anode is converted to a reducing chemical cathode by adding a reducing chemical and converted back from a reducing chemical cathode to an atmospheric anode by removing the reducing chemical.

6. The reducing chemical of claim 1, wherein the depleted reducing chemical is recycled to non-depleted reducing chemical by applying a reverse electrical current with another electrode.

7. The dual configuration rechargeable battery and reducing chemical of claim 1 and a recycling station, wherein at the recycling station: the depleted reducing chemical is extracted from the rechargeable battery; stored in a depleted reducing chemical tank; recycled to non-depleted reducing chemical by application of an electric current; stored in a non-depleted reducing chemical tank; and the non-depleted reducing chemical is transferred to the rechargeable battery.

8. The reducing chemical electrode of claim 1, a first phase reducing chemical, and a second phase reducing chemical, wherein the reducing chemical provides a two phase process where the two state electrolyte in the compound state is converted to a first phase compound state with the first phase reducing chemical generating a current and the first phase compound state is converted to the reduced state with the second phase reducing chemical generating a current.

9. An electric powered vehicle with a reducing chemical tank and a dual configuration rechargeable battery used to power a vehicle electric motor where the dual configuration rechargeable battery comprises:
a two state electrolyte with a reduced state and an compound state where chemical reactions change the states with a resultant electrical flow or an electrical flow changes the state with resultant chemical reactions;
a dual use electrode associated with the two state electrolyte, which serves as a cathode in a first configuration and as an anode in a second configuration;
an atmospheric electrode acting as an anode where atmospheric gases can enter into chemical reactions with the two state electrolyte in the reduced state resulting in the compound state and electrical current flow with the dual use electrode as a cathode;
a reducing chemical electrode acting as a cathode where the reducing chemical enters into a chemical reaction with the two state electrolyte in the compound state resulting in the reduced state, depletion of the reducing chemical electrode, and electrical flow with the dual use electrode as an anode;
a reducing chemical that coverts the atmospheric anode to the reducing chemical cathode by adding the reducing chemical and converted back from the reducing chemical cathode to an atmospheric anode by removing the reducing chemical;
where the battery in the first configuration generates an electrical current to power the vehicle motor by chemical reaction with the atmospheric anode changing the two state electrolyte from the reduced state to the compound state and in the second configuration generates an electrical current to power the vehicle motor by chemical reaction with the reducing chemical changing the two state electrolyte from the compound state to the reduced state and the reducing chemical depleted.

10. The vehicle of claim 9 wherein the battery in the first configuration, the two state electrolyte is converted from the compound state to the reduced state by application of a reverse electrical current to the dual use electrode as a cathode and atmospheric electrode as an anode.

11. The vehicle of claim 9 where the battery in the first configuration and the two state electrolyte in the compound state, the battery is converted to the second configuration by adding the reducing chemical, generating an electrical current to drive the motor, and convert the two state electrolyte in the compound state to the reduced state.

12. The vehicle of claim 9 where the battery in the second configuration and the two state electrolyte in the reduced state, the battery is converted to the first configuration by removing the reducing chemical, generating an electrical current to drive the motor, and convert the two state electrolyte in the reduced state to the compound state.

13. The vehicle of claim 9 with a storage tank holding non-depleted reducing chemical, the battery in the first configuration is converted to the second configuration by moving the non-depleted reducing chemical from the storage tank to the battery.

14. The vehicle of claim 9 with an empty reducing chemical storage tank, the battery in the second configuration is converted to the first configuration by moving the depleted reducing chemical from the battery into the storage tank.

15. The vehicle of claim 9 with a storage tank for the reducing chemical providing an external input and external output where the storage tank may be filled or emptied from an external source with a detachable connector matching the storage tank external input and external output without exposing the reducing chemical to the external environment.

16. The vehicle of claim 9 with a storage tank for the reducing chemical and a recycling station, wherein the recycling station provides: means to extract the depleted reducing chemical from the storage tank; means to store depleted reducing chemical in a depleted reducing chemical tank; means to recycle depleted reducing chemical by application of an electric current converting it to non-depleted reducing chemical; means to store non-depleted reducing chemical in a non-depleted reducing chemical tank; and, means to transfer the non-depleted reducing chemical to the storage tank.

17. The reducing chemical electrode of claim 9, a first phase reducing chemical, and a second phase reducing chemical, wherein the reducing chemical provides a two phase process where the two state electrolyte in the compound state is converted to a first phase compound state with the first phase reducing chemical generating a current and the first phase compound state is converted to the reduced state with the second phase reducing chemical generating a current.

18. A reducing chemical recovery station for a vehicle with a dual configuration battery and storage tank with an external input and external output for a reducing chemical, where the reducing chemical is in either a depleted state or a non-depleted state, comprising:
a connector with an input matching the external output and an output matching the external input;
a processing unit providing:
means to extract depleted reducing chemical from a vehicle storage tank though the connector;
means to store the depleted reducing chemical;
means to convert depleted reducing chemical to non-depleted reducing chemical by applying an electrical current;
means to store the non-depleted reducing chemical;
means to fill the vehicle storage tank with non-depleted reducing chemical through the connector.
